(19) United States
(12) Patent Application Publication
(10) Pub. No.: US 2012/0242793 A1
(43) Pub. Date: Sep. 27, 2012

(54) DISPLAY DEVICE AND METHOD OF CONTROLLING THE SAME

(76) Inventors: Soungmin Im, Seoul (KR); Sangki Kim, Seoul (KR)

(21) Appl. No.: 13/052,885

(22) Filed: Mar. 21, 2011

(51) Int. Cl. H04N 13/02; H04N 13/04

(52) U.S. Cl. 348/46; 348/E13.074

(57) ABSTRACT

Disclosed are a display device and a method of controlling the same. The display device and the method of controlling the same include a camera capturing a gesture made by a user, a display displaying a stereoscopic image, and a controller controlling presentation of the stereoscopic image in response to a distance between the gesture and the stereoscopic image on a virtual space and an approach direction of the gesture with respect to the stereoscopic image. Accordingly, the presentation of the stereoscopic image can be controlled in response to a distance and an approach direction with respect to the stereoscopic image.

### BACKGROUND

1. Field

This document relates to a display device and a method of controlling the same, and more particularly, to a display device and a method of controlling the same, capable of controlling the presentation (i.e., display) of an image in response to a distance and an approach direction with respect to a stereoscopic image.

2. Related Art

The functional diversification of terminals, such as personal computers, laptop computers, cellular phones or the like, has led to the implementation thereof as multimedia player type terminals equipped with complex functions of, for example, capturing pictures or videos, reproducing music or video files, providing game services, receiving broadcasting signals or the like.

Terminals, as multimedia devices, may also be called display devices as they are generally configured to display a variety of image information.

Such display devices may be classified into portable and stationary type according to the mobility thereof. Examples of portable display devices may include laptop computers, cellular phones and the like, while examples of stationary display devices may include televisions, monitors for desktop computers and the like.

### SUMMARY

It is, therefore, an object of the present invention is to efficiently provide a display device and a method of controlling the same, capable of controlling the presentation of an image in response to a distance and an approach direction with respect to a stereoscopic image.

According to an aspect of the present invention, there is provided a display device including: a camera capturing a gesture of a user; a display displaying a stereoscopic image; and a controller controlling presentation of the stereoscopic image in response to a distance between the gesture and the stereoscopic image in a virtual space and an approach direction of the gesture with respect to the stereoscopic image.

According to another aspect of the present invention, there is provided a display device including: a camera capturing a gesture of a user; a display displaying a stereoscopic image having a plurality of sides; and a controller executing a function assigned to at least one of the plurality of sides in response to an approach direction of the gesture with respect to the at least one of the plurality of sides in a virtual space.

According to another exemplary embodiment of the present invention, there is provided a method of controlling the display device, including: displaying a stereoscopic image; acquiring a gesture with respect to the displayed stereoscopic image; and controlling presentation of the stereoscopic image in response to a distance between the gesture and the stereoscopic image in a virtual space, and an approach direction of the gesture with respect to the stereoscopic image.

According to another exemplary embodiment of the present invention, there is provided a method of controlling a display device, including: displaying a stereoscopic image having a plurality of sides; acquiring a gesture with respect to the displayed stereoscopic image; and executing a function assigned to at least one of the plurality of sides in response to an approach direction of the gesture with respect to the at least one of the plurality of sides in a virtual space.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram of a display device relating to an embodiment of this document;

FIG. 2 is a conceptional view for explaining a proximity depth of a proximity sensor;

FIGS. 3 and 4 are views for explaining a method for displaying a stereoscopic image by using a binocular parallax according to an exemplary embodiment of the present invention;

FIG. 5 is a flowchart according to an exemplary embodiment of the present invention;

FIGS. 6 through 9 are views for explaining a method for displaying a stereoscopic image associated with FIG. 5;

FIG. 10 is a flowchart of the process of acquiring a user's gesture associated with FIG. 5, in more detail;

FIG. 11 is a view depicting a gesture for control acquisition associated with FIG. 10;

FIG. 12 is a flowchart of the process of controlling the presentation of the stereoscopic image associated with FIG. 5, in more detail;

FIGS. 13 and 14 are views depicting examples of a displayed stereoscopic image;

FIGS. 15 and 16 are views depicting gestures with respect to a stereoscopic image;

FIGS. 17 through 20 are views depicting display changes according to a gesture with respect to a stereoscopic image;

FIGS. 21 through 26 are views depicting gestures with respect to a stereoscopic image in the form of a polyhedron;

FIGS. 27 through 31 are views depicting pointers for selecting a stereoscopic image;

FIGS. 32 through 34 are views depicting the process of selecting any one of a plurality of stereoscopic images;

FIGS. 35 and 36 are views depicting an operation of a feedback unit; and

FIGS. 37 through 39 are views depicting an operation of a display device relating to another exemplary embodiment of this document.

### DETAILED DESCRIPTION OF THE EMBODIMENTS

This document will now be described more fully with reference to the accompanying drawings, in which exemplary embodiments of this document are shown. This document may, however, be embodied in many different forms and should not be construed as being limited to the embodiments set forth herein; rather, there embodiments are provided so that this disclosure will be thorough and complete, and will fully convey the concept of this document to those skilled in the art.

Hereinafter, a mobile terminal relating to this document will be described below in more detail with reference to the accompanying drawings. In the following description, suffixes “module” and “unit” are given to components of the mobile terminal in consideration of only facilitation of description and do not have meanings or functions discriminated from each other.

The mobile terminal described in the specification can include a cellular phone, a smart phone, a laptop computer, a digital broadcasting terminal, personal digital assistants (PDA), a portable multimedia player (PMP), a navigation system and so on.

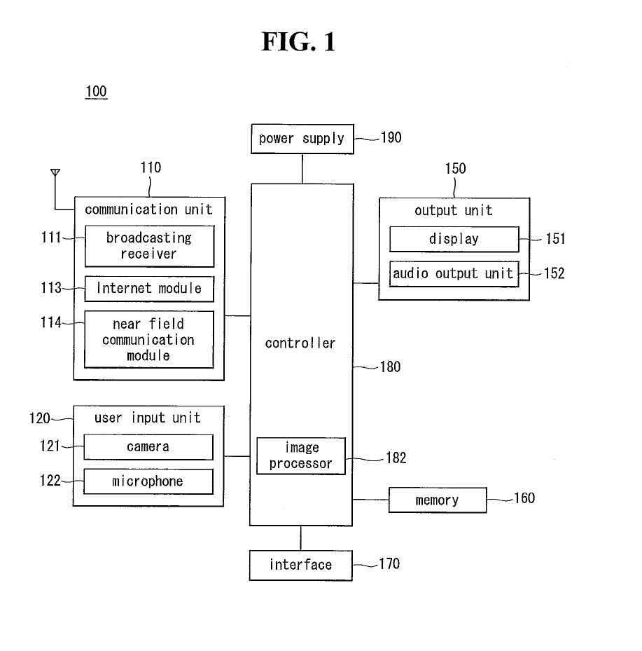

FIG. 1 is a block diagram of a display device relating to an embodiment of this document.

As shown, the display device 100 may include a communication unit 110, a user input unit 120, an output unit 150, a memory 160, an interface 170, a controller 180, and a power supply 190. Not all of the components shown in FIG. 1 may be essential parts and the number of components included in the display device 100 may be varied.

The communication unit 110 may include at least one module that enables communication between the display device 100 and a communication system or between the display device 100 and another device. For example, the communication unit 110 may include a broadcasting receiving module 111, an Internet module 113, and a near field communication module 114.

The broadcasting receiving module 111 may receive broadcasting signals and/or broadcasting related information from an external broadcasting management server through a broadcasting channel.

The broadcasting channel may include a satellite channel and a terrestrial channel, and the broadcasting management server may be a server that generates and transmits broadcasting signals and/or broadcasting related information or a server that receives previously created broadcasting signals and/or broadcasting related information and transmits the broadcasting signals and/or broadcasting related information to a terminal. The broadcasting signals may include not only TV broadcasting signals, radio broadcasting signals, and data broadcasting signals but also signals in the form of a combination of a TV broadcasting signal and a radio broadcasting signal of a data broadcasting signal.

The broadcasting related information may be information on a broadcasting channel, a broadcasting program or a broadcasting service provider, and may be provided even through a communication network.

The broadcasting related information may exist in various forms. For example, the broadcasting related information may exist in the form of an electronic program guide (EPG) of a digital multimedia broadcasting (DMB) system or in the form of an electronic service guide (ESG) of a digital video broadcast-handheld (DVB-H) system.

The broadcasting receiving module 111 may receive broadcasting signals using various broadcasting systems. The broadcasting signals and/or broadcasting related information received through the broadcasting receiving module 111 may be stored in the memory 160.

The Internet module 113 may correspond to a module for Internet access and may be included in the display device 100 or may be externally attached to the display device 100.

The near field communication module 114 may correspond to a module for near field communication. Further, Bluetooth®, radio frequency identification (RFID), infrared data association (IrDA), ultra wideband (UWB) and/or ZigBee® may be used as a near field communication technique.

The user input 120 is used to input an audio signal or a video signal and may include a camera 121 and a microphone 122.

The camera 121 may process image frames of still images or moving images obtained by an image sensor in a video telephony mode or a photographing mode. The processed image frames may be displayed on a display 151. The camera 121 may be a 2D or 3D camera. In addition, the camera 121 may be configured in the form of a single 2D or 3D camera or in the form of a combination of the 2D and 3D cameras.

The image frames processed by the camera 121 may be stored in the memory 160 or may be transmitted to an external device through the communication unit 110. The display device 100 may include at least two cameras 121.

The microphone 122 may receive an external audio signal in a call mode, a recording mode or a speech recognition mode and process the received audio signal into electric audio data. The microphone 122 may employ various noise removal algorithms for removing or reducing noise generated when the external audio signal is received.

The output unit 150 may include the display 151 and an audio output module 152.

The display 151 may display information processed by the display device 100. The display 151 may display a user interface (UI) or a graphic user interface (GUI) relating to the display device 100. In addition, the display 151 may include at least one of a liquid crystal display, a thin film transistor liquid crystal display, an organic light-emitting diode display, a flexible display and a three-dimensional display. Some of these displays may be of a transparent type or a light transmissive type. That is, the display 151 may include a transparent display. The transparent display may include a transparent liquid crystal display. The rear structure of the display 151 may also be of a light transmissive type. Accordingly, a user may see an object located behind the body of terminal through the transparent area of the terminal body, occupied by the display 151.

The display device 100 may include at least two displays 151. For example, the display device 100 may include a plurality of displays 151 that are seated on a single plane at a predetermined distance or integrated displays. The plurality of displays 151 may also be seated on different planes.

Further, when the display 151 and a sensor sensing touch (hereafter referred to as a touch sensor) form a layered structure that is referred to as a touch screen, the display 151 may be used as an input device in addition to an output device. The touch sensor may be in the form of a touch film, a touch sheet, and a touch pad, for example.

The touch sensor may convert a variation in pressure applied to a specific portion of the display 151 or a variation in capacitance generated at a specific portion of the display 151 into an electric input signal. The touch sensor may sense pressure of touch as well as position and area of the touch.

When the user applies a touch input to the touch sensor, a signal corresponding to the touch input may be transmitted to a touch controller. The touch controller may then process the signal and transmit data corresponding to the processed signal to the controller 180. Accordingly, the controller 180 can detect a touched portion of the display 151.

The audio output module 152 may output audio data received from the radio communication unit 110 or stored in the memory 160. The audio output module 152 may output audio signals related to functions, such as a call signal incoming tone and a message incoming tone, performed in the display device 100.

The memory 160 may store a program for operation of the controller 180 and temporarily store input/output data such as a phone book, messages, still images, and/or moving images. The memory 160 may also store data about vibrations and sounds in various patterns that are output from when a touch input is applied to the touch screen.

The memory 160 may include at least a flash memory, a hard disk type memory, a multimedia card micro type memory, a card type memory, such as SD or XD memory, a random access memory (RAM), a static RAM (SRAM), a read-only memory (ROM), an electrically erasable programmable ROM (EEPROM), a programmable ROM (PROM) magnetic memory, a magnetic disk or an optical disk. The display device 100 may also operate in relation to a web storage performing the storing function of the memory 160 on the Internet.

The interface 170 may serve as a path to all external devices connected to the mobile terminal 100. The interface 170 may receive data from the external devices or power and transmit the data or power to internal components of the display device terminal 100 or transmit data of the mobile terminal 100 to the external devices. For example, the interface 170 may include a wired/wireless headset port, an external charger port, a wired/wireless data port, a memory card port, a port for connecting a device having a user identification module, an audio I/O port, a video I/O port, and/or an earphone port.

The controller 180 may control overall operations of the mobile terminal 100. For example, the controller 180 may perform control and processing for voice communication. The controller 180 may also include an image processor 182 for pressing image, which will be explained later.

The power supply 190 receives external power and internal power and provides power required for each of the components of the display device 100 to operate under the control of the controller 180.

Various embodiments described in this document can be implemented in software, hardware or a computer readable recording medium. According to hardware implementation, embodiments of this document may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and/or electrical units for executing functions. The embodiments may be implemented by the controller 180 in some cases.

According to software implementation, embodiments such as procedures or functions may be implemented with a separate software module executing at least one function or operation. Software codes may be implemented according to a software application written in an appropriate software language. The software codes may be stored in the memory 160 and executed by the controller 180.

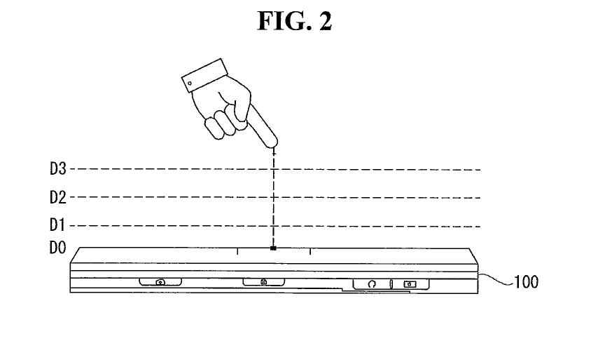

FIG. 2 is a conceptional view for explaining a proximity depth of the proximity sensor.

As shown in FIG. 2, when a pointer such as a user's finger approaches the touch screen, the proximity sensor located inside or near the touch screen senses the approach and outputs a proximity signal.

The proximity sensor can be constructed such that it outputs a proximity signal according to the distance between the pointer approaching the touch screen and the touch screen (referred to as “proximity depth”).

The distance in which the proximity signal is output when the pointer approaches the touch screen is referred to as a detection distance. The proximity depth can be known by using a plurality of proximity sensors having different detection distances and comparing proximity signals respectively output from the proximity sensors.

FIG. 2 shows the section of the touch screen in which proximity sensors capable of sensing three proximity depths are arranged. Proximity sensors capable of sensing less than three or more than four proximity depths can be arranged in the touch screen.

Specifically, when the pointer completely comes into contact with the touch screen (D0), it is recognized as contact touch. When the pointer is located within a distance D1 from the touch screen, it is recognized as proximity touch of a first proximity depth. When the pointer is located in a range between the distance D1 and a distance D2 from the touch screen, it is recognized as proximity touch of a second proximity depth. When the pointer is located in a range between the distance D2 and a distance D3 from the touch screen, it is recognized as proximity touch of a third proximity depth. When the pointer is located at longer than the distance D3 from the touch screen, it is recognized as cancellation of proximity touch.

Accordingly, the controller 180 can recognize the proximity touch as various input signals according to the proximity distance and proximity position of the pointer with respect to the touch screen and perform various operation controls according to the input signals.

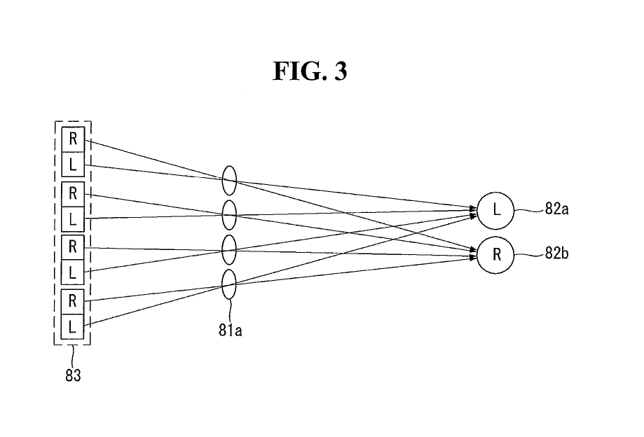

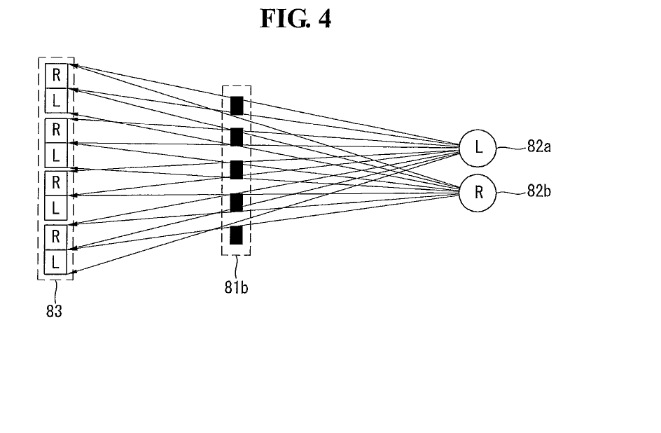

FIGS. 3 and 4 are views illustrating a method for displaying a stereoscopic image using binocular parallax according to an exemplary embodiment of the present invention. Specifically, FIG. 3 shows a scheme using a lenticular lens array, and FIG. 4 shows a scheme using a parallax barrier.

Binocular parallax (or stereo disparity) refers to the difference in vision of viewing an object between a human being's (user's or observer's) left and right eyes. When the user's brain combines an image viewed by the left eye and that viewed by the right eye, the combined image makes the user feel stereoscopic. Hereinafter, the phenomenon in which the user feels stereoscopic according to binocular parallax will be referred to as a ‘stereoscopic vision’, and an image causing a stereoscopic vision will be referred to as a ‘stereoscopic image’. Also, when a particular object included in an image causes the stereoscopic vision, the corresponding object will be referred to as a ‘stereoscopic object’.

A method for displaying a stereoscopic image according to binocular parallax is classified into a glass type method and a glassless type method. The glass type method may include a scheme using tinted glasses having a wavelength selectivity, a polarization glass scheme using a light blocking effect according to a deviation difference, and a time-division glass scheme alternately providing left and right images within a residual image time of eyes. Besides, the glass type method may further include a scheme in which filters each having a different transmittance are mounted on left and right eyes and a cubic effect with respect to a horizontal movement is obtained according to a time difference of a visual system made from the difference in transmittance.

The glassless type method, in which a cubic effect is generated from an image display surface, rather than from an observer, includes a parallax barrier scheme, a lenticular lens scheme, a microlens array scheme, and the like.

With reference to FIG. 3, in order to display a stereoscopic image, a display module 151 includes a lenticular lens array 81a. The lenticular lens array 81a is positioned between a display surface 81 on which pixels (L) to be input to a left eye 82a and pixels (R) to be input to a right eye 82b are alternately arranged along a horizontal direction, and the left and right eyes 82a and 82b, and provides an optical discrimination directionality with respect to the pixels (L) to be input to the left eye 82a and the pixels (R) to be input to the right eye 82b. Accordingly, an image which passes through the lenticular lens array 81a is separated by the left eye 82a and the right eye 82b and thusly observed, and the user's brain combines (or synthesizes) the image viewed by the left eye 82a and the image viewed by the right eye 82b, thus allowing the user to observe a stereoscopic image.

With reference to FIG. 4, in order to display a stereoscopic image, the display module 151 includes a parallax barrier 81b in the shape of a vertical lattice. The parallax barrier 81b is positioned between a display surface 81 on which pixels (L) to be input to a left eye 82a and pixels (R) to be input to a right eye 82b are alternately arranged along a horizontal direction, and the left and right eyes 82a and 82b, and allows images are separately observed at the left eye 82a and the right eye 82b. Accordingly, the user's brain combines (or synthesizes) the image viewed by the left eye 82a and the image viewed by the right eye 82b, thus allowing the user to observe a stereoscopic image. The parallax barrier 81b is turned on to separate incident vision only in the case of displaying a stereoscopic image, and when a planar image is intended to be displayed, the parallax barrier 81b may be turned off to allow the incident vision to pass therethrough without being separated.

Meanwhile, the foregoing methods for displaying a stereoscopic image are merely for explaining exemplary embodiments of the present invention, and the present invention is not meant to be limited thereto. Beside the foregoing methods, a stereoscopic image using binocular parallax may be displayed by using various other methods.

Hereinafter, concrete embodiments of the present invention will be described.

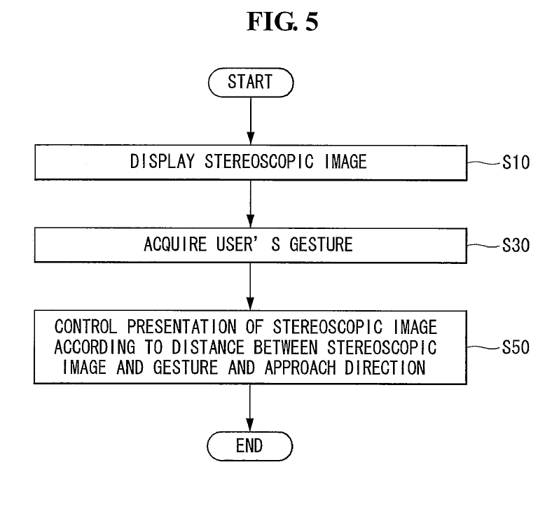

FIG. 5 is a flowchart according to an exemplary embodiment of the present invention.

As shown therein, the controller 180 of the display device 100, according to an exemplary embodiment of the present invention, may display a stereoscopic image in operation S10.

As described above, the stereoscopic image may be an image displayed by using a binocular disparity, that is, a stereo disparity. By presenting an image using the stereo disparity, a stereoscopic image with depth or perspective may be displayed. For example, in such a manner, an image may look as if protruding or receding from a display surface of the display 151. The stereoscopic image using the stereo disparity is different from a related-art two-dimensional (2D) display that gives just a 3D-like impression. The method of displaying a stereoscopic image by using the stereo disparity will be described later in more detail.

When the stereoscopic image is displayed, a user's gesture may be acquired in operation S30.

The user's gesture may be captured by the camera 121 provided in the display device 100. For example, assuming that the display device 100 is a fixed TV, the camera 121 may capture a motion made by a user in front of the TV. Also, assuming that the display device 100 is a mobile terminal, the camera 121 may capture a hand motion of the user in front or at the back of the mobile terminal.

When the user's gesture is acquired, the presentation of the stereoscopic image may be controlled according to a distance and a location relationship between the stereoscopic image and the gesture in operation S50.

The controller 180 may learn (i.e., determine) the location of the gesture made by the user. That is, an image captured by the camera 121 may be analyzed to thereby provide an analysis of the location of the gesture in the virtual space. The location of the gesture may be a relative distance with respect to the body of a user or the display surface of the display 151. In this case, the distance may refer to a location within a 3D space. For example, the distance may indicate a specific spot having x-y-z components from an origin such as a specific point on the body of the user.

The controller 180 may determine the location of the displayed stereoscopic image in the virtual space. That is, the controller 180 may determine the location of the stereoscopic image in the virtual space giving the user an impression that an image is displayed therein due to the effect of the stereo disparity. For example, this means that in the case where an image has positive (+) depth to look as if protruding toward the user from the display surface of the display 151, the controller 180 may determine the extent to which the image protrudes, and the location thereof.

The controller 180 may determine a direction in which the gesture approaches the stereoscopic image, that is, an approach direction of the gesture with respect to the stereoscopic image. That is, since the controller 180 learns the location of the gesture and the location of the stereoscopic image in the virtual space, it can be determined which side (or face) of the stereoscopic image the gesture is made for. For example, in the case in which the stereoscopic image in the form of a polyhedron is displayed in the virtual space, the controller 180 may determine whether the user's gesture is directed toward the front side of the stereoscopic image or the lateral or rear side of the stereoscopic image.

Since the controller 180 may determine the approach direction of the gesture with respect to the stereoscopic image, a function corresponding to the approach direction may be executed. For example, in the case in which the stereoscopic image is approached from its front side thereof and touched, a function of activating the stereoscopic image may be executed. Also, in the case in which the stereoscopic image is approached from the rear side thereof and touched, a specific function corresponding to the stereoscopic image may be executed.

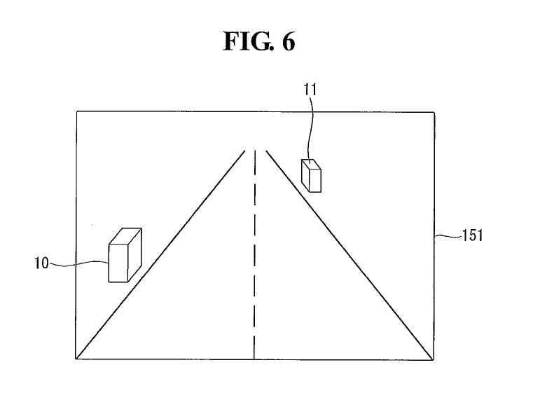

FIG. 6 illustrates an example of a stereoscopic image including a plurality of image objects 10 and 11.

For example, the stereoscopic image depicted in FIG. 6 may be an image obtained by the camera 121. The stereoscopic image includes a first image object 10 and a second image object 11. Here, it is assumed that there are two image objects 10 and 11 for ease of description; however, in actuality, more than two image objects may be included in the stereoscopic image.

The controller 180 may display an image acquired in real time by the camera 121 on the display 151 in the form of a preview.

The controller 180 may acquire one or more stereo disparities respectively corresponding to one or more of the image objects in operation S110.

In the case where the camera 121 is a 3D camera capable of acquiring an image for the left eye (hereinafter, referred to as “a left-eye image”) and an image for the right eye (hereinafter, referred to as “a right-eye image”), the controller 180 may use the acquired left-eye and right-eye images to acquire the stereo disparity of each of the first image object 10 and the second image 11.

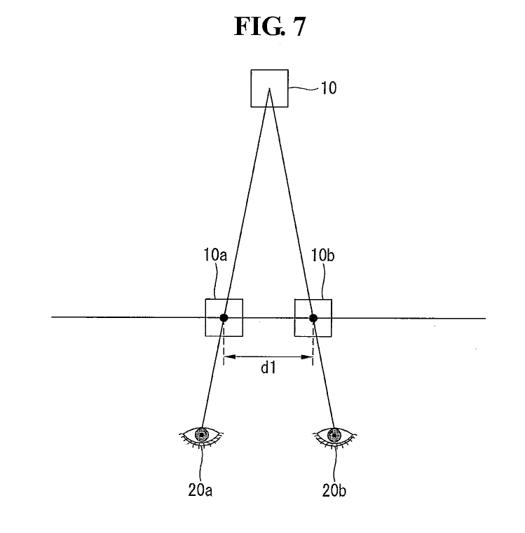

FIG. 7 is a view for explaining a stereo disparity of an image object included in a stereoscopic image.

For example, referring to FIG. 7, the first image object 10 may have a left-eye image 10a presented to the user's left eye 20a, and a right-eye image 10b presented to the right eye 20b.

The controller 180 may acquire a stereo disparity d1 corresponding to the first image object 10 on the basis of the left-eye image 10a and the right-eye image 10b.

In the case where the camera 121 is a 2D camera, the controller 180 may convert a 2D image, acquired by the camera 121, into a stereoscopic image by using a predetermined algorithm for converting a 2D image into a 3D image, and display the converted image on the display 151.

Furthermore, by using left-eye and right-eye images created by the above image conversion algorithm, the controller 180 may acquire the respective stereo disparities of the first image object 10 and the second image object 11.

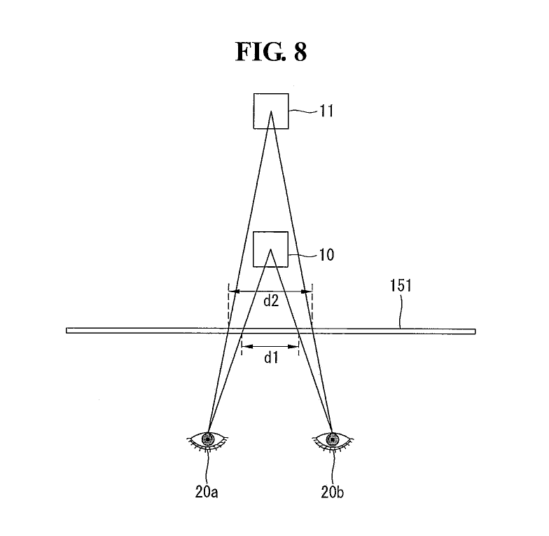

FIG. 8 is a view for comparing the stereo disparities of the image objects 10 and 11 depicted in FIG. 6.

Referring to FIG. 8, the stereo disparity dl of the first image object 10 is different from a stereo disparity d2 of the second image object 11. Furthermore, as shown in FIG. 8, since the stereo disparity d2 of the second image object 11 is greater than the stereo disparity d1 of the first image object 10, the second image object 11 is viewed as if being located farther away from the user than the first image object 10.

The controller 180 may acquire one or more graphic objects respectively corresponding to one or more of the image objects in operation. The controller 180 may display the acquired one or more graphic objects on the display 151 so as to have a stereo disparity.

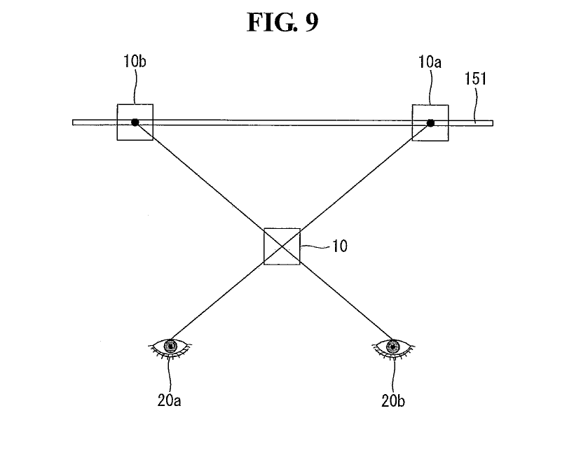

FIG. 9 illustrates the first image object 10 that may look as if protruding toward the user. As shown in FIG. 9, the locations of the left-eye image 10a and the right-eye image 10b on the display 151 may be opposite to those depicted in FIG. 7. When the left-eye image 10 and the right-eye image 10b are displayed in the opposite manner as above, the images are also presented to the left eye 20a and the right eye 20b in the opposite manner. Thus, the user can view the displayed image as if it is located in front of the display 151, that is, at the intersection of sights. That is, the user may perceive positive (+) depth in relation to the display 151. This is different from the case of FIG. 7 in which the user perceives negative (−) depth that gives the user an impression that the first image object 10 is displayed at the rear of the display 151.

The controller 180 may give the user the perception of various types of depth by displaying a stereoscopic image having positive (+) or negative depth (−) according to needs.

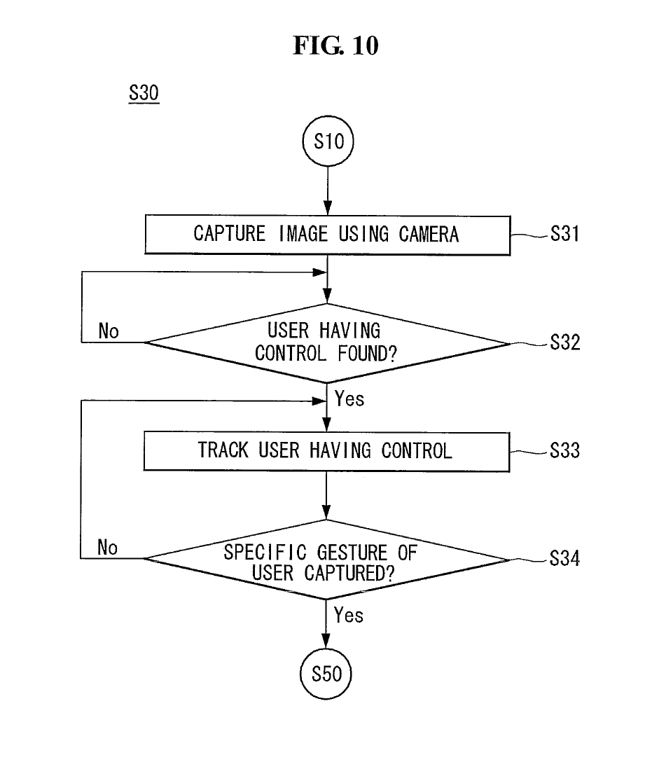

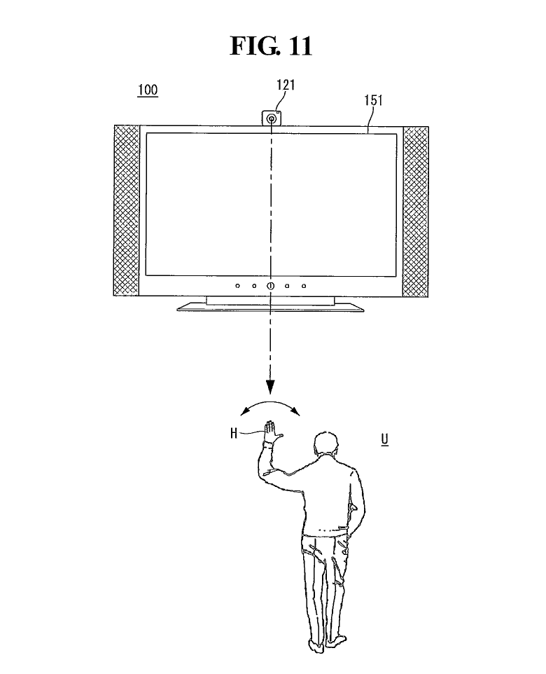

FIG. 10 is a flowchart illustrating the process of acquiring the user's gesture depicted in FIG. 5 in more detail. FIG. 11 is a view depicting a gesture for control acquisition related to FIG. 10.

As shown in those drawings, the acquiring of the user's gesture by the controller 180 of the display device in operation S30 of FIG. 5, according to an exemplary embodiment of the present invention, may include initiating capturing using the camera 121 in operation S31.

The controller 180 may activate the camera 121. When the camera 121 is activated, the controller 180 may capture an image of the surroundings of the display device 100.

It is determined whether a user having control is found in operation S32, and the user having control may be tracked in operation S33.

The controller 180 may control the display device 100 on the basis of a gesture made by a specific user having control. For example, this means that in the case where a plurality of people are located in front of the display device 100, the controller 180 may allow a specific function of the display device 100 to be performed on the basis of only a gesture made by a specific person having acquired control among those in front of the display device 100.

As shown in FIG. 11, the control upon the display device 100 may be granted to a user U who has made a specific gesture. For example, in the case where the user U's motion of raising and waving his hand H to the left and right is set as a gesture for acquiring control, the control may be granted to a user having made such a gesture.

When a user having control is found, the user with control may be tracked. The granting and tracking of the control may be performed on the basis of an image captured by the camera 121 provided in the display device 100. That is, this means that the controller 180 analyzes the captured image to thereby continuously determine whether or not a specific user U exists, the specific user U performs a gesture required for control acquisition, the specific user U is moving, and the like.

While the user having control is being tracked, it may be determined whether or not a specific gesture of the user is captured in operation 34.

The specific gesture of the user may be a gesture for executing a specific function of the display device 100 and terminating the specific function being performed. For example, the specific gesture may be a gesture to select various menus displayed as stereoscopic images by the display device 100. Hereinafter, the operation in which the presentation of the stereoscopic image is controlled according to the user's gesture (S50 of FIG. 5) will be described in detail.

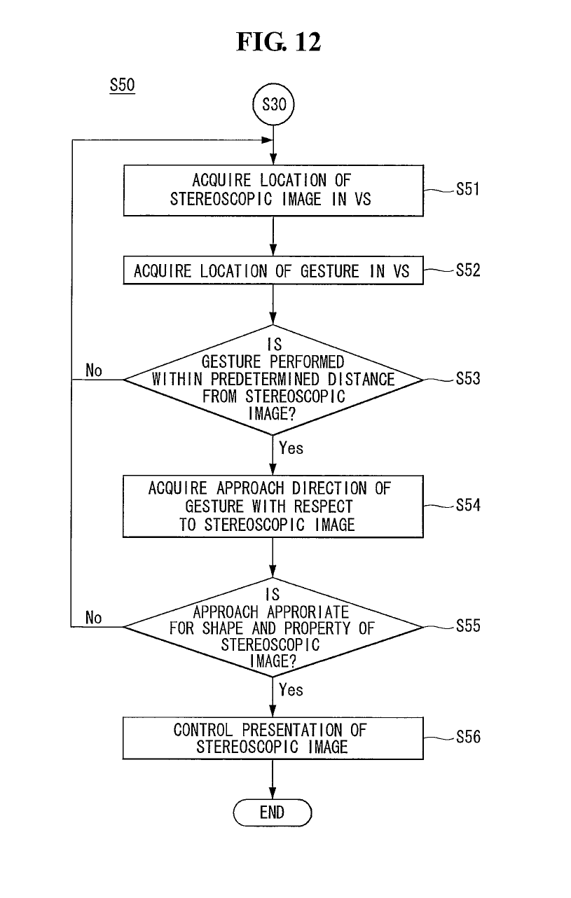

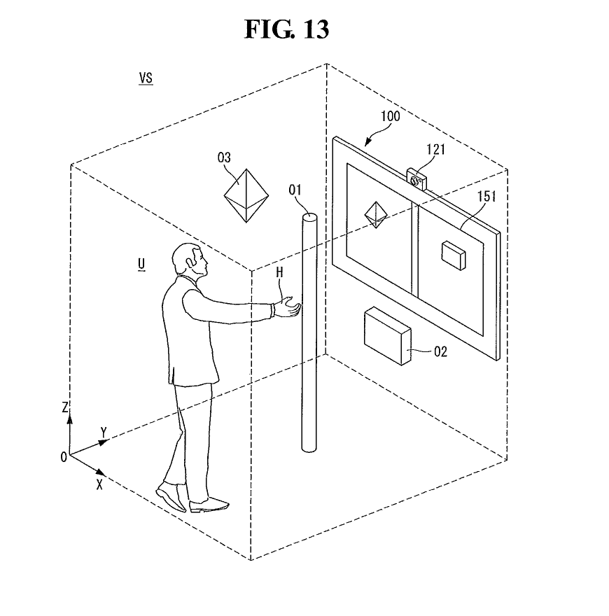

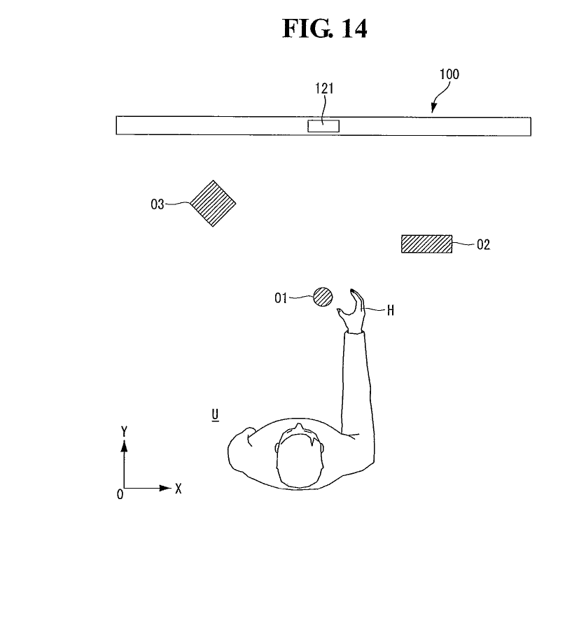

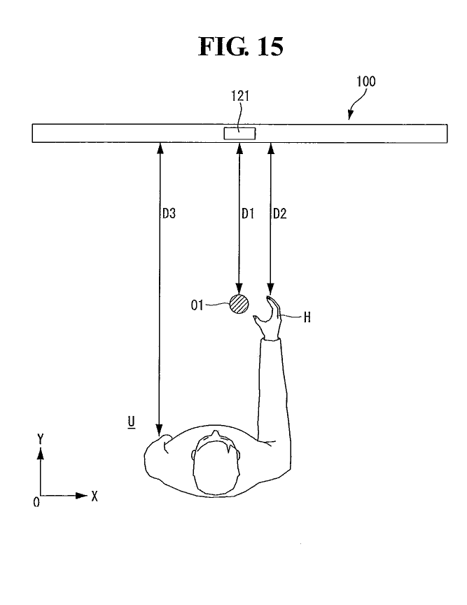

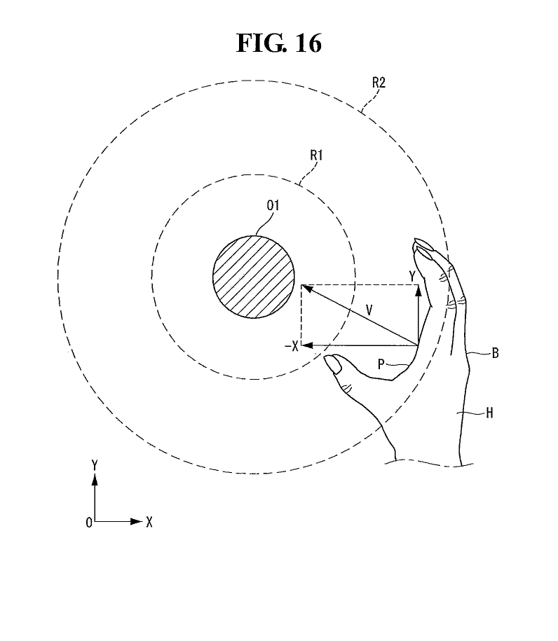

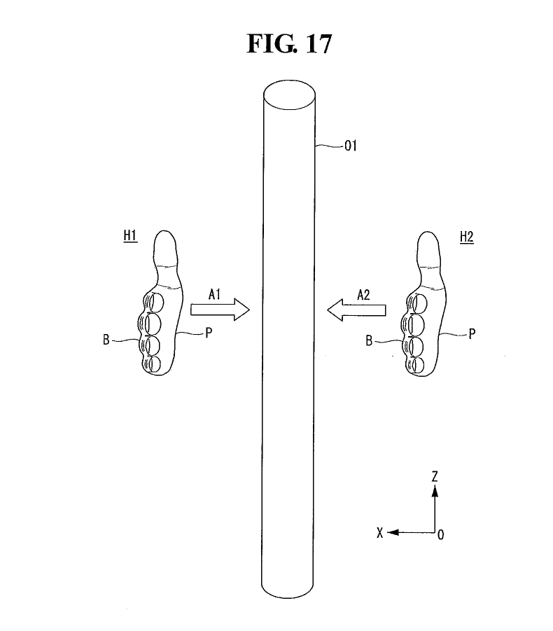

FIG. 12 is a flowchart of the process of controlling the presentation of the stereoscopic image associated with FIG. 5, in more detail. FIGS. 13 and 14 are views depicting examples of a displayed stereoscopic image. FIGS. 15 and 16 are views depicting gestures with respect to a stereoscopic image. FIGS. 17 through 20 are views depicting changes in display (i.e., presentation) according to a gesture with respect to a stereoscopic image.

As shown in those drawings, the display device 100 according to an exemplary embodiment of the present invention may appropriately control the presentation of the stereoscopic image in response to the specific gesture made by the user U with respect to the stereoscopic image.

The controller 180 may acquire the location of the stereoscopic image in the virtual space VS in operation S51.

As shown in FIG. 13, the virtual space VS may refer to a space that gives the user U an impression that individual objects O1 to O3 of the stereoscopic image displayed by the display device 100 are located in a 3D space. That is, the virtual space VS may be a space where an image, being displayed substantially on the display 151, looks as if protruding toward the user U with positive (+) depth or receding against the user U with negative (−) depth. Each of the objects O1 to O3 may look as if floating in the virtual space VS or being extended in a vertical or horizontal direction of the virtual space VS.

When each of the objects O1 to O3 is displayed in the virtual space VS, the user U may have an impression that he can take hold (grip) of the display objects O1 to O3 with his hand. This effect is more clearly demonstrated in an object looking as if being located near the user U. For example, as shown in FIG. 14, the user U may have a visual illusion that the first object O1 is located right in front of him. In this case, the user U may have an impression that he may hold the first object O1 with his hand H.

The controller 180 may learn the location of the stereoscopic image displayed in the virtual space VS. That is, based on the locations of the left-eye and right-eye images 10a and 10b of FIG. 7 on the display 151, the controller 180 may determine the location of the stereoscopic image in the virtual space VS, presented to the user U.

The location of the gesture in the virtual space VS may be acquired in operation S52.

The location of the gesture in the virtual space VS may be acquired by using the camera 121 provided in the display device 100. That is, the controller 180 may analyze an image acquired as the camera 121 continuously tracks an image of the user U.

As shown in FIG. 15, the controller 180 may determine a first distance D1 from the display device 100 to the first object O1, a second distance D2 from the display device 100 to the hand H of the user U, and a third distance D3 from the display device 100 to the user U. The first to third distances D1 to D3 may be determined by analyzing the image captured by the camera 121 and using the location of the displayed first object O1 that has been known to the controller 180.

It may be determined whether the gesture is made within a predetermined distance to the stereoscopic image in operation S53.

For the execution of a specific function on the basis of the user U's gesture, the user U may make a specific gesture within the predetermined distance. For example, the user U may put out his hand H toward the first object O1 to make a motion associated with the first object O1.

As shown in FIG. 16, the user U may stretch out his hand H to approach the first object O1 within a predetermined radius.

The controller 180 may determine a direction V in which the user U's hand H approaches, through an image analysis. That is, the controller 180 may determine whether the hand H approaches the first object O1 or another object adjacent to the first object O1, by using the trace of the gesture made by the hand H.

When it is determined that the gesture is made within the predetermined distance with respect to the stereoscopic image, an approach direction of the gesture with respect to the stereoscopic image may be acquired in operation S54.

When the gesture is made by the hand H of the user U, the controller 180 may determine which direction (i.e., side) of the hand H faces the first object O1. For example, the controller 180 may determine whether a palm side P or a back side B of the palm faces the first object O1.

It may be determined which one of the palm side P and the back side B approaches the first object O1, by analyzing the image acquired by the camera 121 and/or tracking the trace of the hand H.

As shown in FIG. 17, the controller 180 may determine in which direction the hand H1 or H2 approaches the first object O1. That is, the controller 180 may determine that the palm side P approaches the first object O1 in the case of a first hand H1 and determine that the back side B of the hand approaches the first object O1 in the case of a second hand H2.

When the palm side P moves in a first direction A1 as in the case of the first hand H1, the controller 180 may determine that the user U moves to take a grip on (i.e., hold) the first object O1. When the back side B moves in a second direction A2 as in the case of the second hand H2, the controller 180 may determine that the user U is not moving to take a grip on the first object O1. That is, this means that it may be determined which motion the user is to make with respect to a specific stereoscopic image, on the basis of the gesture of the user U, in particular, a hand motion. Accordingly, the controller 180 may enable the execution of a specific function on the basis of a specific hand motion. That is, the case of the first hand H1 may be linked to a motion of grabbing the first object O1, and the case of the second hand H2 may be linked to a motion of pushing the first object O1.

It may be determined whether the approach is appropriate for the external shape and properties of the stereoscopic image in operation S55, and the presentation of the stereoscopic image may be controlled in operation S56.

The controller 180 may allow stereoscopic images to have different characteristics according to shapes of the stereoscopic images and/or properties of entities respectively corresponding to the stereoscopic images. That is, a stereoscopic image representing a rigid object such as an iron bar, and a stereoscopic image representing an elastic object such as a rubber bar may have different responses to a user's gesture. In the case in which a stereoscopic image represents an entity such as an iron bar, the shape of the stereoscopic image may be maintained as it is even when a user makes a motion of holding the corresponding image. In contrast, in the case in which a stereoscopic image represents an entity such as a rubber bar, the shape thereof may be changed when a user makes a motion of holding the same.

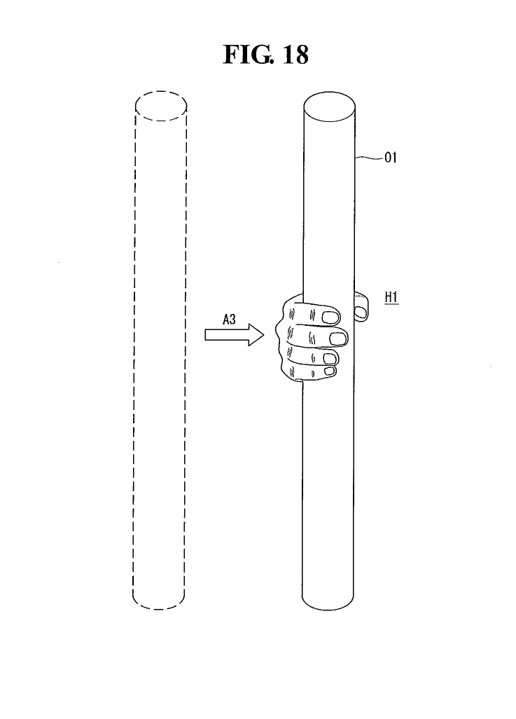

If the first object O1 is set to have rigidity as shown in FIG. 18, the user U may make a gesture of taking hold of the first object O1 and moving it in a third direction A3.

When the first hand H1 of the user U makes a holding motion after approaching the first object O1 within a predetermined distance, the controller 180 may cause the stereoscopic image to look as if the first object O1 is held by the hand. Accordingly, the user can perform a function of moving the first object O1 in the third direction A3.

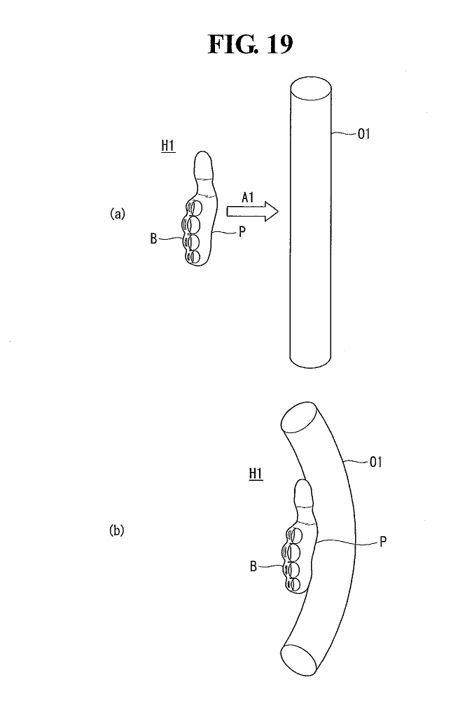

As shown in FIG. 19, the controller 180 may allow the presentation of the response of the first object O1 to the user's gesture to be varied according to the properties of an entity corresponding to the first object O1.

As shown in FIG. 19A, the user may move the first hand H1 toward the first object O1, that is, in the first direction A1. The controller 180 may detect the motion of the first hand H1 through the camera 121.

As shown in FIG. 19B, the user's first hand H1 may virtually come into contact with the first object O1. In this case, if the first object O1 represents a soft material such as a rubber bar, the controller 180 may create a visual effect of bending the first object O1 in its portion where the virtual contact with the first hand H1 has occurred.

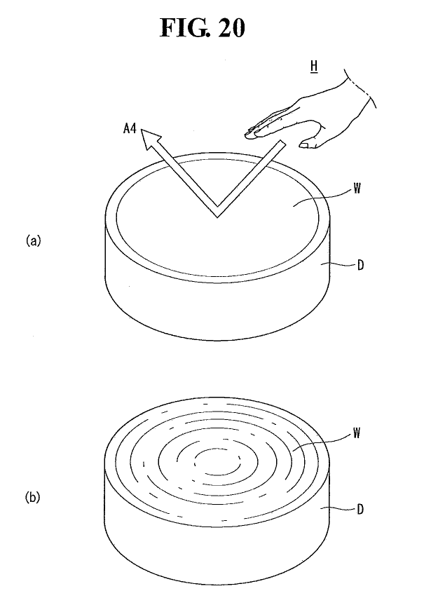

As shown in FIG. 20A, the user may make a gesture toward liquid W contained in a bowl D in a fourth direction A4.

As shown in FIG. 20B, when the user makes a gesture with respect to the liquid W, the controller 180 may create an effect of causing waves in the liquid W in response to the gesture of the hand H.

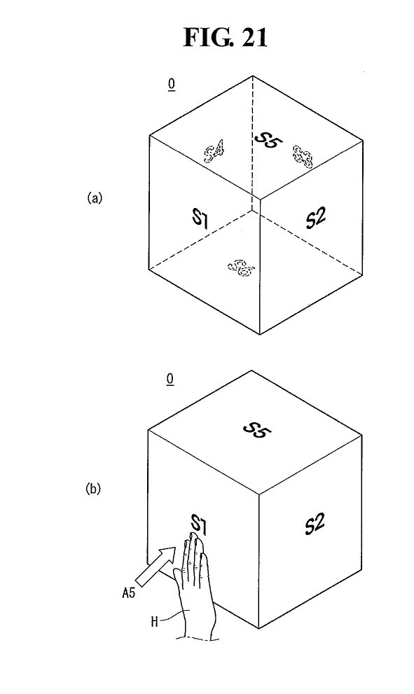

FIGS. 21 through 26 are views illustrating gestures with respect to a stereoscopic image in the form of a polyhedron.

As shown in those drawings, the controller 180 of the display device 100 according to an exemplary embodiment of the present invention may perform a specific function in response to a user's gesture with respect to a specific side of a stereoscopic image in the form of a polyhedron with a plurality of sides (i.e., faces).

As shown in FIG. 21A, the controller 180 may display an object O that can give a user a stereoscopic impression caused by a stereo disparity. The object O may have a cubic shape, and a specific function may be assigned to each side of the cubic shape. For example, a gesture of a touch on a first side S1 may execute a function of activating the object O, a touch on a second side S2 may execute a calling function, and a touch on a third side S3 may execute a message sending function. In such a manner, each side of the object O may have each function assigned thereto.

As shown in FIG. 21B, the user may make a gesture of touching the first side S1, the front side, in a fifth direction A5 by using his hand H. That is, this means that the user makes a gesture of pushing his hand forward away from the body of the user. When the gesture of touching the first side S1 in the fifth direction A5 is input, the controller 180 may execute a function allocated to the first side S1.

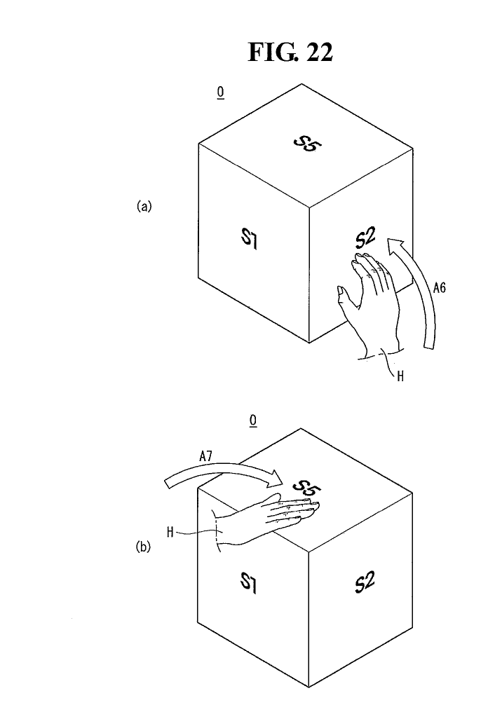

As shown in FIG. 22A, the user may make a gesture of touching the second side S2 in a sixth direction A6. The touching in the sixth direction A6 may be a gesture of touching the lateral side of the object O. When the gesture of touching the second side S2 is performed, the controller 180 may execute a function corresponding to the second side S2. That is, different functions may be executed according to directions in which the user touches the object O.

As shown in FIG. 22B, the user may make a gesture of touching a fifth side S5 of the object O in a seventh direction A7. When the fifth side S5 is touched, the controller 180 may perform a function corresponding to the fifth side S5.

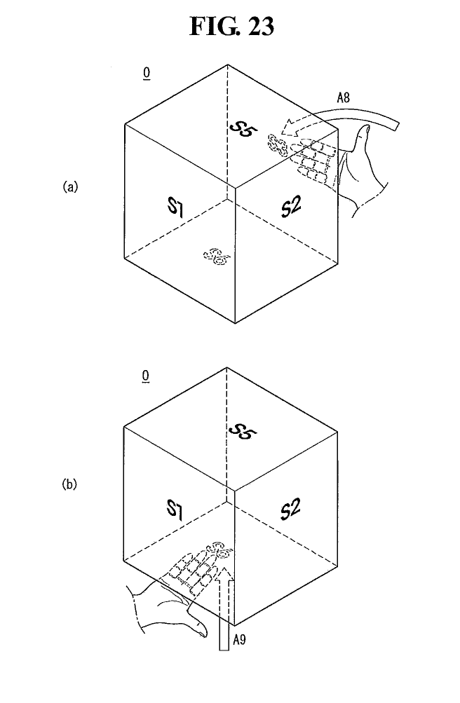

The user may make a gesture of touching the rear side of the object O, the third side S3 thereof, in an eighth direction A8 as shown in FIG. 23A, or a gesture of touching a sixth side S6, the bottom of the object O, in a ninth direction A9. In this case, the controller 180 may perform an individual function in response to the gesture with respect to each side.

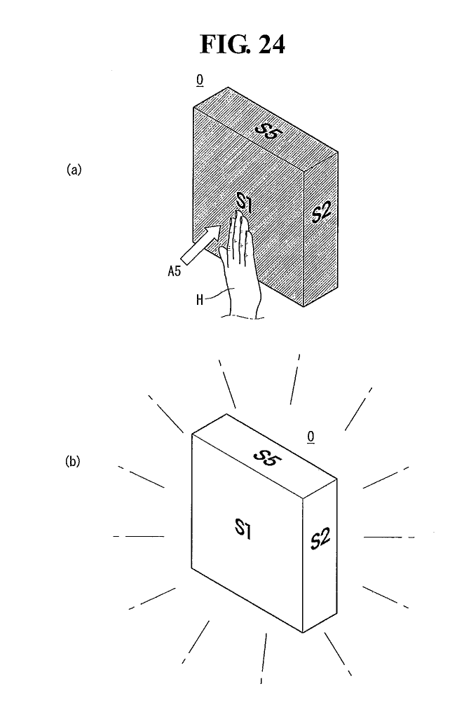

As shown in FIG. 24A, the user may make a gesture of touching the front side of the object O. That is, the user may make a motion of approaching the object O from its front side and touching the first side S1. Before the user approaches the object O in the fifth direction AS and touches the first side S1, the object O may be in an inactivated state. For example, a selection on the object O may be restricted in order to prevent an unintentional gesture from executing a function corresponding to the object O.

As shown in FIG. 24B, the user's touch on the first side S1 may enable the activation of the object O. That is, the execution of a function corresponding to the object O may be enabled by the gesture. The object O, when activated, may be displayed brightly to indicate the activation.

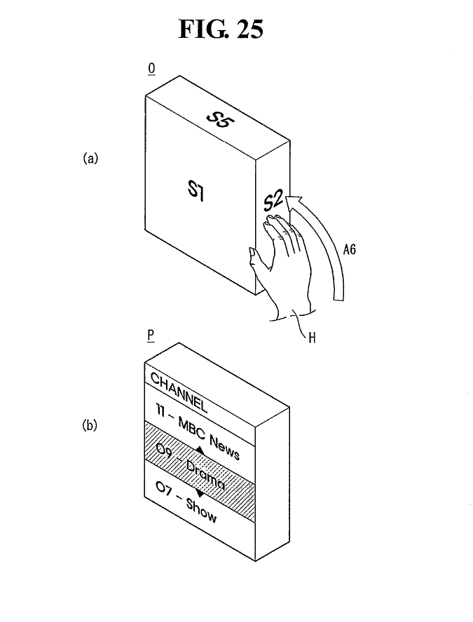

As shown in FIG. 25A, the user may make a gesture of touching the lateral side of the object O. That is, the user may make a gesture of touching the second side S2, one of lateral sides of the object O, in the sixth direction A6. The controller 180 of the display device 100, according to an exemplary embodiment of the present invention, may make different responses according to which spot on the displayed object the gesture is intended for.

As shown in FIG. 25B, pop-up objects P related to channel changes may be displayed in response to the user's gesture with respect to the second side S2. This is different from the case in which the touch on the first side S1 executes the function of activating the object O. Even when the object O is in an inactivated state, the function may be executed by the gesture with respect to the second side S2.

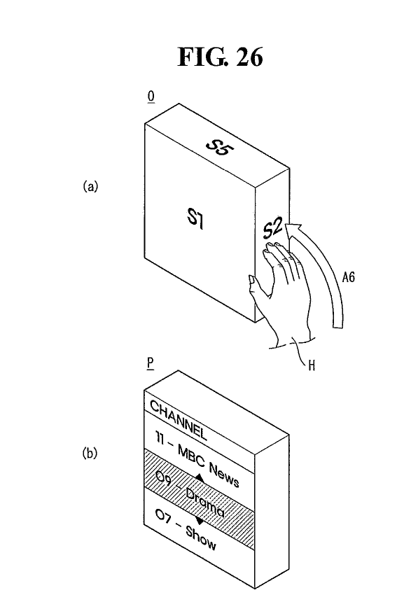

As shown in FIG. 26A, the user may make a gesture of holding the object O. The gesture of holding the object O may bring about a similar result to that of the gestures of touching the plurality of sides. For example, the user may make a gesture of simultaneously touching the first side S1 and the third side S3 of the object O from the lateral side of the object O.

When the user makes a gesture of holding the object O, a different function from that in the case of a gesture of separately touching each side may be executed. For example, assuming that a first function is executed by a gesture with respect to the first side S1 and a second function is executed by a gesture with respect to the third side S3, a gesture of simultaneously touching the first and third sides S1 and S3 may execute a third function. In this case, the third function may be totally different from the first and second functions or may be the simultaneous execution of the first and second functions.

As shown in FIG. 26B, by the user's gesture of holding the object, a function of recording a currently viewed broadcasting channel may be executed.

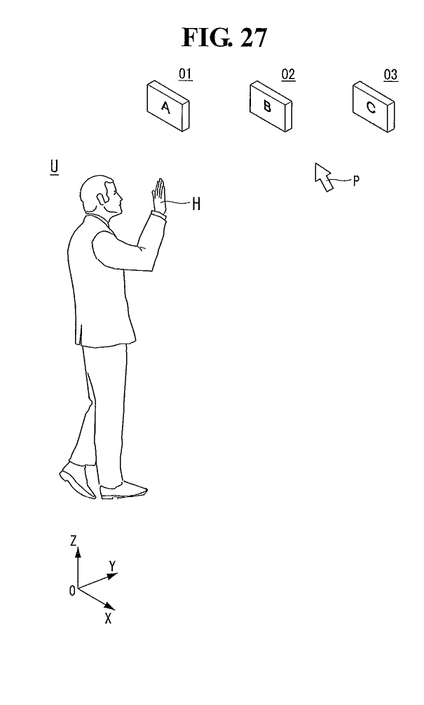

FIGS. 27 through 31 are views illustrating a pointer for selection in a stereoscopic image.

As shown in those drawings, the display device according to an exemplary embodiment of the present invention may display a pointer P corresponding to a gesture of a user U. In this case, the pointer P is displayed so as to give the user an impression of 3D distance.

As shown in FIG. 27, first to third objects O1 to O3 may be displayed in the virtual space. The user U may select the first to third objects O1 to O3 directly by using his hand H, or by using the pointer P. For example, the pointer P may be displayed in the space at a predetermined distance from the user U.

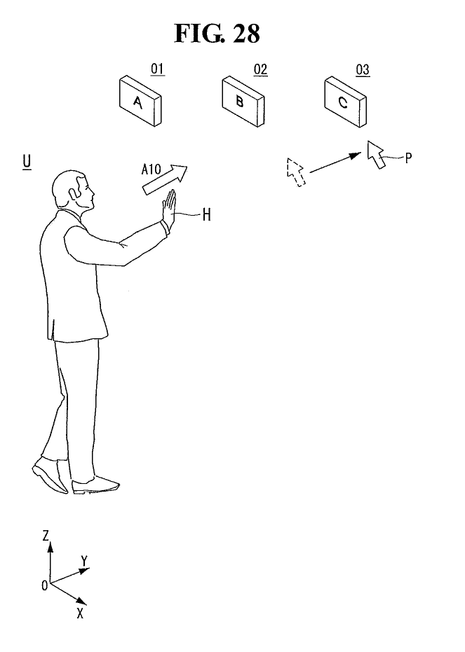

As shown in FIG. 28, when the user U moves his hand in a tenth direction A10, the pointer P may move toward the third object O3 in response to the user's hand motion. In this case, the movement of the pointer P may be determined according to a distance between a preset reference location and the gesture. For example, in the case in which the body of the user U is set as a reference location, if the hand H moves closer or farther away from the display device 100, the pointer P may move accordingly. The reference location may be set by the user.

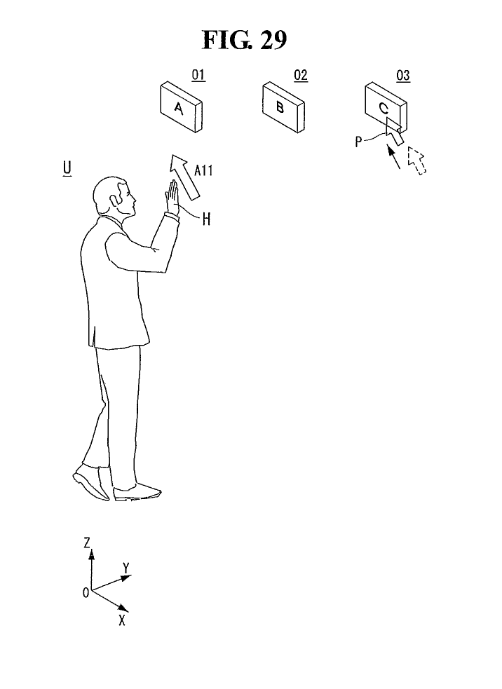

As shown in FIG. 29, when the user U moves the hand H in an eleventh direction A11, the pointer P may move toward the third object O3 in a direction corresponding to an eleventh direction A11.

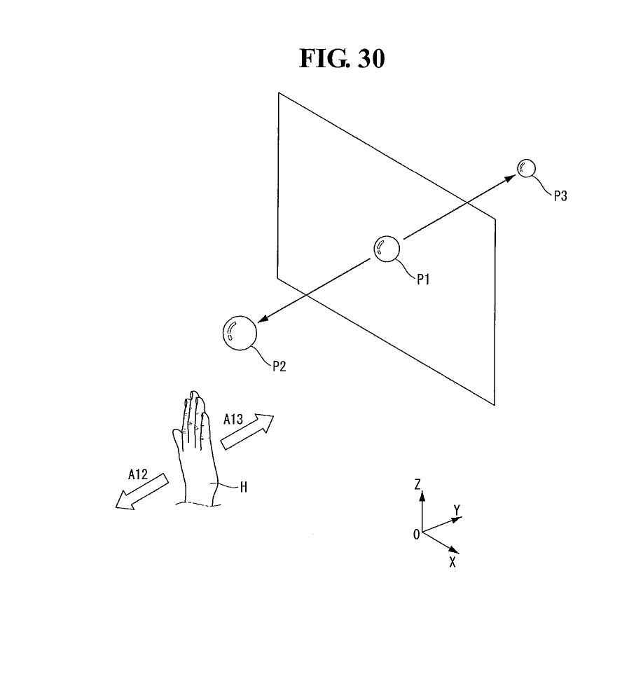

As shown in FIG. 30, the pointer P may undergo size changes according to the distance from the reference location. For example, the pointer P at the reference location may have a size of a first pointer P1.

The pointer P having the size of the first point P1 at the reference location may become bigger to have a size of a second pointer P2 as the hand H moves in a twelfth direction A12. That is, the pointer P increases in size as it approaches the user. Furthermore, the pointer P having the size of the first pointer P1 at the reference location may become smaller to have a size of a third pointer P3 as the hand H moves in a thirteenth direction A13. That is, the pointer P may decrease in size as it moves farther away from the user.

Since the pointer changes in size according to the distance from the user, the perspective caused by a stereo disparity may be more clearly presented. Also, this may provide a guide to the depth of an object selectable by the user's gesture.

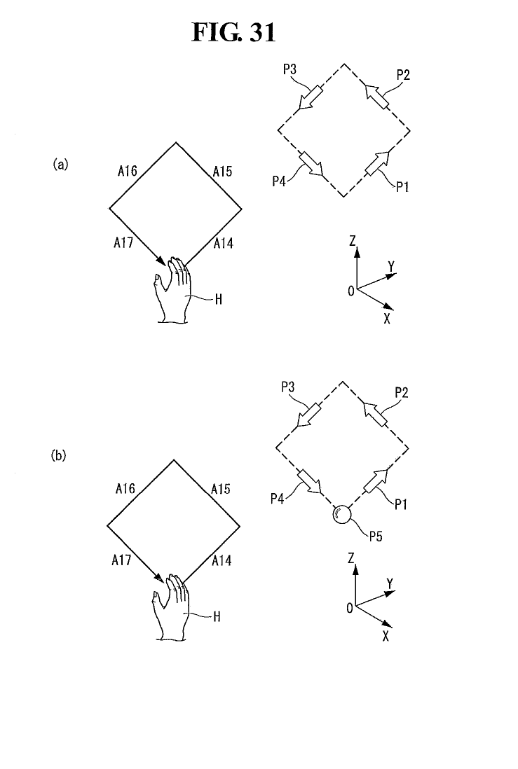

As shown in FIG. 31, the pointer P may change according to the direction of a gesture made by the user.

As shown in FIG. 31A, the hand H of the user may move in fourteenth to seventeenth directions A14 to A17. When the user's hand H moves, the controller 180 may change the shape of the pointer accordingly and display the same. That is, when the hand H moves in the fourteenth direction S14, a direction in which the hand H moves farther away from the user, the first pointer P1 having an arrow pointing the fourteenth direction A14 may be displayed. That is, first to fourth pointers P1 and P4 may have shapes respectively corresponding to the fourteenth to seventeenth directions A14 to A17.

As shown in FIG. 31B, the pointer may indicate whether the hand H is moving or stopped. That is, while the user stops making a motion at a specific location, a circular fifth pointer P5 that indicate no direction is displayed. When the hand H moves, the first to fourth P1 to P4 may be displayed accordingly.

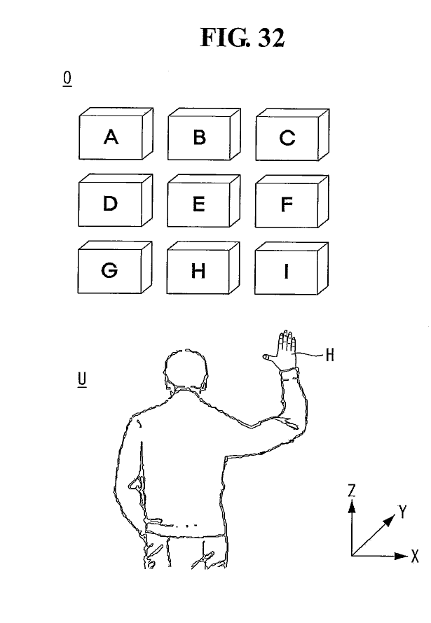

FIGS. 32 through 34 are views illustrating the process of selecting any one of a plurality of stereoscopic images.

As shown in those drawings, when a gesture for selecting a specific image from among the plurality of stereoscopic images is input, the controller 180 of the display device 100 according to an exemplary embodiment of the present invention changes the presentation of another stereoscopic image. Accordingly, the selection with respect to the specific stereoscopic image can be facilitated.

As shown in FIG. 32, a plurality of objects O may be displayed adjacent to each other in a virtual space. That is, objects A to I may be displayed.

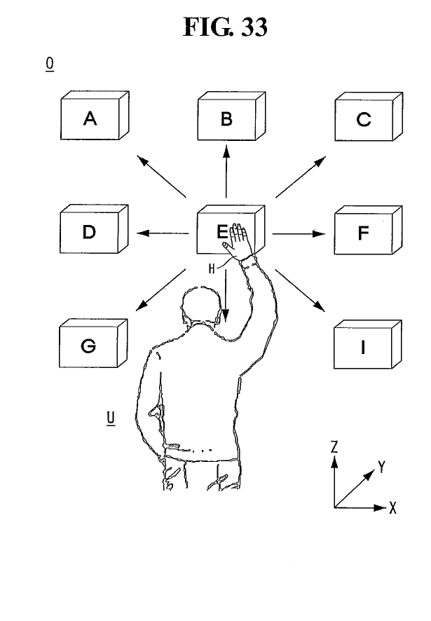

As shown in FIG. 33, the user U may make a gesture of selecting object E by moving his hand H. When the user U makes the gesture of selecting the object E, the controller 180 may cause the objects other than the object E to look as if moving away from the object E. That is, when it is determined that the user U intends to select a specific object, objects other than the specific object are caused to move away from the specific object, thereby reducing the possibility of selecting an unintended object.

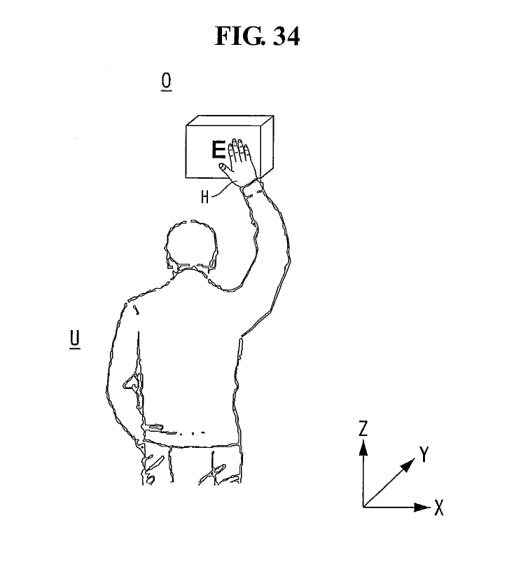

As shown in FIG. 34, when the user makes a gesture of selecting a specific object, the controller 180 may release the display of other objects other than the specific object. That is, objects, other than the specific object, may be made to disappear, Furthermore, when the user stops making the gesture, the disappeared object may be displayed again.

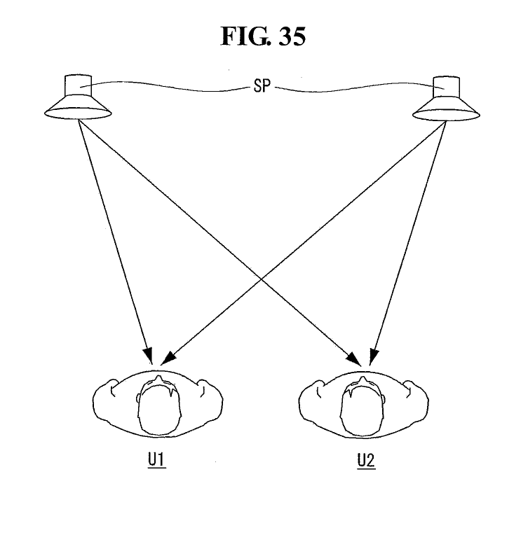

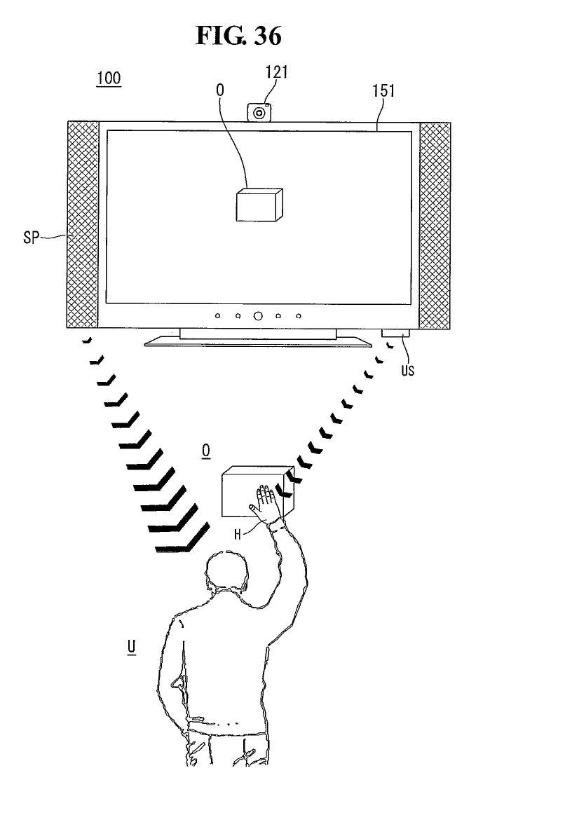

FIGS. 35 and 36 are views illustrating the operation of a feedback unit.

As shown in those drawings, the display device 100 according to an exemplary embodiment of the present invention may give the user U feedback on a gesture.

The feedback may be recognized through an auditory sense and/or a tactile sense. For example, when the user makes a gesture of touching or holding a stereoscopic image, the controller 180 may provide the user with corresponding sounds or vibrations. The feedback for the user may be performed by using a directional speaker SP or an ultrasonic generator US, a feedback unit provided in the display device 100.

As shown in FIG. 35, the directional speaker SP may selectively provide sound to a specific user of first and second users U1 and U2. That is, only a selected user may be provided with sound through the directional speaker SP capable of selectively determining the propagation direction or transmission range of the sound.

As shown in FIG. 36, the display device 100 may allow an object O to be displayed in a virtual space. When the user U makes a gesture with respect to the object O displayed in the virtual space, the controller 180 may give the user U feedback corresponding to the gesture. For example, the controller may provide the user U with sounds through the directional speaker SP or vibrations through the ultrasonic generator US. The ultrasonic generator US may generate ultrasonic waves directed toward a specific point. When the ultrasonic waves directed toward the specific spot collide with the back of the hand H of the user U, the user U may feel pressure. By controlling the pressure given to the user, the user may recognize it as vibrations.

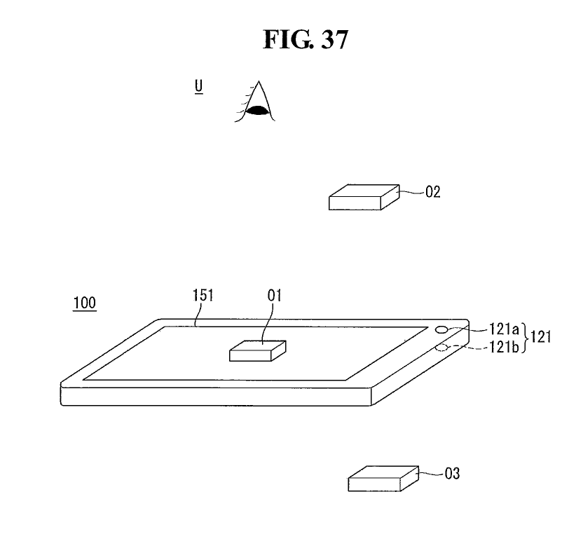

FIGS. 37 through 39 are views illustrating the operation of a display device according to another exemplary embodiment of the present invention.

As shown in those drawings, the display device 100 according to another exemplary embodiment of the present invention may be a mobile terminal which can be carried by a user. In the case in which the display device 100 is a portable device, a user's gesture with respect to not only the front side of the display device 100 but also the rear side thereof may be acquired and corresponding functions may be performed accordingly.

As shown in FIG. 37, the display device 100 may display a stereoscopic image through the display 151. The first to third objects O1 to O3 of the stereoscopic image may be displayed as if protruding or receding from a display surface of the display 151. For example, the first object O1 giving the perception of the same depth as that of the display surface of the display 151, the second object O2 looking as if protruding toward the user, and the third object O3 displayed as if receding against the user may be displayed in the virtual space.

The body of the display device 100 may be provided with a first camera 121a facing the front side and a second camera 121b facing the back side.

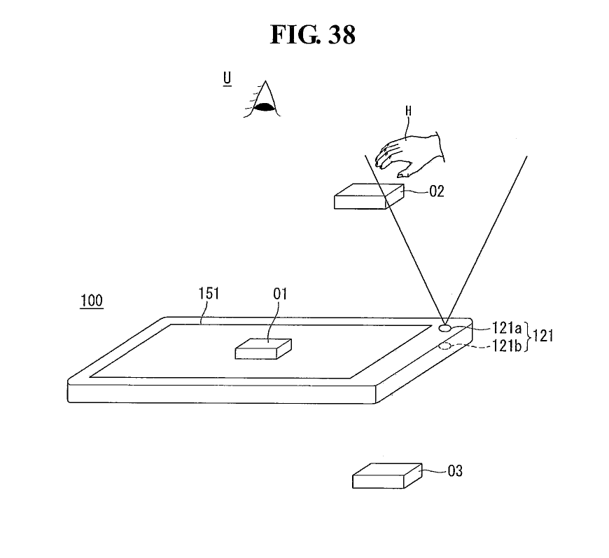

As shown in FIG. 38, the user may make a gesture with respect to the second object O2 displayed in front of the display device 100. That is, the user may make a gesture of touching or holding the third object O3 with his hand H. The user's gesture with respect to the second object O2 may be captured by the first camera 121a facing the front side.

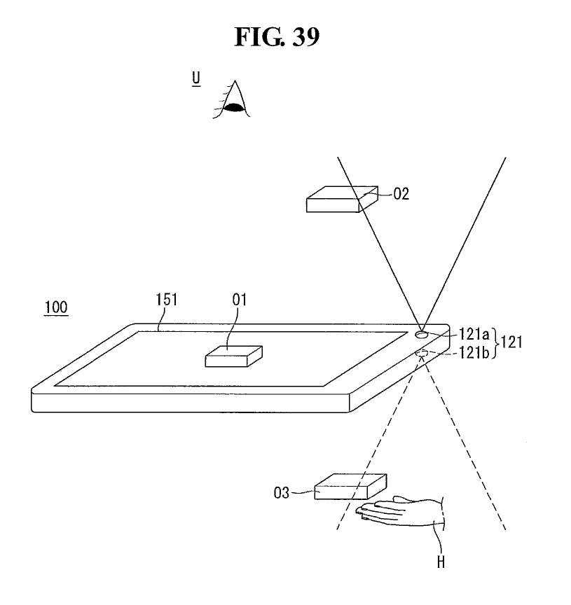

As shown in FIG. 39, the user may make a gesture with respect to the third object O3 displayed at the rear of the display device 100. That is, the user may make a gesture of touching or grabbing the third object O3 with the hand H. The user's gesture with respect to the third object O3 may be captured by the second camera 121b facing the back side.

Since the display device 100 can be controlled upon acquiring not only a gesture made in front of the display device 100 but also a gesture made at the rear of the display device 100, various operations can be made according to the depth of a stereoscopic image.

As set forth herein, in the display device and the method of controlling the same, according to exemplary embodiments of the present invention, the presentation of an image can be controlled in response to a distance and an approach direction with respect to a stereoscopic image.

While the present invention has been shown and described in connection with the exemplary embodiments, it will be apparent to those skilled in the art that modifications and variations can be made without departing from the spirit and scope of the invention as defined by the appended claims.

1. A display device comprising:
a camera configured to capture a gesture performed by a user;
a display configured to display a stereoscopic image; and
a controller configured to control presentation of the stereoscopic image reacting to the gesture performed by the user, the reaction of the stereoscopic image being in response to a distance between the gesture and the stereoscopic image in a virtual space and an approach direction of the gesture with respect to the stereoscopic image.

2. The display device of claim 1, wherein the stereoscopic image comprises a plurality of stereoscopic images, and
wherein, when the gesture is performed within a predetermined distance range of at least one of the plurality of stereoscopic images, the controller is configured to change the presentation of the at least one stereoscopic image.

3. The display device of claim 1, wherein the stereoscopic image comprises a plurality of stereoscopic images, and
wherein, in response to the performed gesture with respect to at least one of the plurality of stereoscopic images, the controller is configured to change a presentation of at least another one of the plurality of stereoscopic images.

4. The display device of claim 3, wherein the controller is configured to change a distance between the at least one of the plurality of stereoscopic images and the at least another one of the plurality of stereoscopic images, and display the at least one of the plurality of stereoscopic images and the another one of the plurality of stereoscopic images.

5. (canceled)

6. The display device of claim 1, wherein the controller is configured to control the presentation of the stereoscopic image according to the approach direction of the gesture with respect to at least one of lateral and rear sides of the stereoscopic image.

7. The display device of claim 1, wherein the controller is configured to change the presentation of the stereoscopic image according to at least one of a shape of the stereoscopic image and a property of an entity corresponding to the stereoscopic image.

8. The display device of claim 1, wherein the controller is configured to change the presentation of the stereoscopic image when interference occurs between a trace of the gesture and the stereoscopic image in the virtual space.

9. The display device of claim 1, wherein the controller is configured to change the presentation of the stereoscopic image according to the gesture comprising a hand motion of the user having control of the display device, and
wherein the hand motion includes at least one of a touch on the stereoscopic image and a grip on the stereoscopic image.

10. The display device of claim 1, wherein the controller is configured to display a stereoscopic image pointer moving in the virtual space in response to the gesture, and
wherein the stereoscopic image pointer has a stereoscopic distance corresponding to a distance between a set reference location and a gesture performance location.

11. (canceled)

12. The display device of claim 10, wherein the stereoscopic image includes a plurality of sides to which different functions are assigned, and
wherein the controller is configured to execute a function corresponding to a side selected by the stereoscopic image pointer from among the plurality of sides.

13. The display device of claim 10, wherein the controller is configured to change a direction indicated by the stereoscopic image pointer according to the approach direction of the gesture, and display the stereoscopic image pointer.

14. (canceled)

15. The display device of claim 1, further comprising a feedback unit configured to generate at least one of a sound or a movement to allow the user to detect at least one of the distance and the approach direction through at least one of an auditory sense and a tactile sense.

16. (canceled)

17. The display device of claim 1, wherein the camera is configured to comprise a first camera and a second camera for respectively capturing images from front and back sides of a body that includes the display,
wherein the controller is configured to acquire the gesture by using one of the first and second cameras according to a perspective of the stereoscopic image in the virtual space with reference to a display surface of the display.

18. The display device of claim 1, wherein the controlling of the presentation of the stereoscopic image is associated with at least one of changing a location of the displayed stereoscopic image, changing a shape of the displayed stereoscopic image, and displaying a stereoscopic image having a function corresponding to the displayed stereoscopic image.

19. A display device comprising:
a camera configured to capture a gesture performed by a user;
a display configured to display a stereoscopic image having a plurality of sides; and
a controller configured to execute a function assigned to at least one of the plurality of sides in response to the gesture with respect to the at least one of the plurality of sides in a virtual space.

20-21. (canceled)

22. A method of controlling the display device, the method comprising:
displaying a stereoscopic image using a display;
acquiring a gesture of a user with respect to the displayed stereoscopic image using a camera; and
controlling presentation of the stereoscopic image reacting to the gesture performed by the user, the reaction of the stereoscopic image being in response to a distance between the gesture and the stereoscopic image in a virtual space, and an approach direction of the gesture with respect to the stereoscopic image.

23. The method of claim 22, wherein the controlling of the presentation includes controlling the presentation of the stereoscopic image in response to the approach direction of the gesture with respect to at least one of lateral and rear sides of the stereoscopic image.

24. The method of claim 22, wherein the controlling of the presentation includes changing the presentation of the stereoscopic image according to at least one of a shape of the stereoscopic image and properties of an entity corresponding to the stereoscopic image.

25. The method of claim 22, wherein the controlling of the presentation includes changing the presentation of the stereoscopic image when interference occurs between the stereoscopic image and a trace of the gesture in the virtual space.

26. The method of claim 22, wherein the gesture with respect to the displayed stereoscopic image is a hand motion of the user, including at least one of a touch and a grip on the stereoscopic image.

27-38. (canceled)
